(19) United States
(12) Patent Application Publication
(10) Pub. No.: US 2006/0208628 A1
(43) Pub. Date: Sep. 21, 2006

(54) Electron emission device and method for manufacturing the same

(76) Inventor: Chang-Soo Lee, Suwon-si (KR)

Correspondence Address: CHRISTIE, PARKER & HALE, LLP, PO BOX 7068, PASADENA, CA, 91109-7068, US

(21) Appl. No.: 11/211,404

(22) Filed: Aug. 24, 2005

(30) Foreign Application Priority Data
Aug. 30, 2004 (KR) 10-2004-0068520

(51) Int. Cl. H01J 1/00; H01J 63/04

(52) U.S. Cl. 313/497; 313/311; 313/495

(57) ABSTRACT

An electron emission device includes a substrate, cathode electrodes formed on the substrate, and electron emission regions electrically connected to the cathode electrodes. Gate electrodes are formed over the cathode electrodes with a first insulating layer interposed therebetween. The gate electrodes have a plurality of opening portions exposing the electron emission regions on the substrate. A focusing electrode is formed over the first insulating layer and the gate electrodes while interposing a second insulating layer. The focusing electrode has opening portions corresponding to the opening portions of the gate electrodes with a size smaller than the size of the opening portions of the gate electrodes.

### CROSS REFERENCE TO RELATED APPLICATION

This application claims priority to and the benefit of Korean Patent Application No. 10-2004-0068520 filed on Aug. 30, 2004 in the Korean Intellectual Property Office, the entire content of which is incorporated herein by reference.

### BACKGROUND OF THE INVENTION

1. Field of the Invention

The present invention relates to an electron emission device, and in particular, to an electron emission device which has an improved structure of a focusing electrode for focusing electron beams and an insulating layer for supporting the focusing electrode, and a method of manufacturing the same.

2. Description of Related Art

Generally, electron emission devices are classified into a first type where a hot cathode is used as an electron emission source, and a second type where a cold cathode is used as the electron emission source.

Among the second type of electron emission devices there are known: a field emitter array (FEA) type, a surface conduction emission (SCE) type, a metal-insulator-metal (MIM) type, and a metal-insulator-semiconductor (MIS) type.

The FEA type electron emission device is based on the principle that when a material having a low work function or a high aspect ratio is used as the electron emission source, electrons are easily emitted from the material under a vacuum atmosphere due to an electric field. A sharp-pointed tip structure based on molybdenum (Mo) or silicon (Si), or a carbonaceous material, such as carbon nanotube, graphite and diamond-like carbon, has been developed to be used as the electron emission source.

The electron emission device using the cold cathode basically has first and second substrates forming a vacuum region, with electron emission regions formed on the first substrate together with driving electrodes for controlling the emission of electrons from the electron emission regions. Phosphor layers are formed on the second substrate together with an electron accelerating electrode for effectively accelerating the electrons emitted from the electron emission regions toward the phosphor layers, causing light emission or image display.

With the above-structured electron emission device, where the electrons emitted from the electron emission regions are migrated toward the second substrate while being widely diffused, the electrons hit the target phosphor layers as well as the neighboring incorrect phosphor layers, thereby deteriorating the screen color purity. Accordingly, approaches have been developed to induce the trajectory of electron beams to the target direction, and enhance the device characteristics.

In this regard, it has been proposed that a focusing electrode should be introduced to control the electron beams. The focusing electrode is usually placed at the topmost area of the electron emission structure while surrounding the electron emission regions. An insulating layer is disposed between the driving electrodes and the focusing electrode to prevent an electrical short circuit between the driving electrodes and the focusing electrode. Furthermore, the insulating layer spaces the focusing electrode from the electron emission regions with a predetermined height. Opening portions are formed at the insulating layer and the focusing electrode while exposing the electron emission regions on the first substrate, thereby allowing the passage of electron beams.

A wet etching is mainly used to form opening portions at the insulating layer. The wet etching, where the target to be etched is dipped in an etching solution, involves an isotropic etching characteristic. Greater the depth of the insulating layer to be etched is, the opening width becomes enlarged. Accordingly, it is difficult with the wet etching process to form opening portions with a high vertical to horizontal ratio.

With the known FEA type electron emission device, electron emission regions are formed on the cathode electrodes, and a first insulating layer and gate electrodes are formed on the cathode electrodes with opening portions exposing the electron emission regions. A second insulating layer and a focusing electrode are formed on the first insulating layer and the gate electrodes. In this case, when the second insulating layer and the first insulating layer are sequentially etched to form opening portions at the respective insulating layers, the second insulating layer is continuously etched even after the formation of the opening portions thereof until the opening portions of the first insulating layer are formed.

Consequently, the opening portion of the second insulating layer is larger in width than that of the first insulating layer, and, as such, the opening portion of the focusing electrode is larger in width than that of the gate electrode. With this structure, the focusing electrode is placed apart from the trajectory of electron beams, and hence, the electron beam focusing efficiency is deteriorated.

Furthermore, as the focusing electrode is placed at the plane higher than the electron emission region, the electron beam focusing efficiency becomes enhanced. However, since it is difficult to form opening portions with a high vertical to horizontal ratio at the second insulating layer, there is a limit to increasing the height of the focusing electrode.

### SUMMARY OF THE INVENTION

In one exemplary embodiment of the present invention, there is provided an electron emission device which has a focusing electrode placed closer to the trajectory of electron beams to enhance the electron beam focusing efficiency, and displays a high resolution screen image by forming opening portions with a high vertical to horizontal ratio at an insulating layer for supporting the focusing electrode, and a method of manufacturing the same.

In an exemplary embodiment of the present invention, the electron emission device includes a substrate, cathode electrodes formed on the substrate, and electron emission regions electrically connected to the cathode electrodes. Gate electrodes are formed over the cathode electrodes while interposing a first insulating layer. The gate electrodes have a plurality of opening portions exposing the electron emission regions on the substrate. A focusing electrode is formed over the first insulating layer and the gate electrodes while interposing a second insulating layer. The focusing electrode has opening portions corresponding to the opening portions of the gate electrodes with a size smaller than that of the latter.

In another exemplary embodiment of the present invention, the electron emission device includes first and second substrates facing each other, cathode electrodes formed on the first substrate, and electron emission regions electrically connected to the cathode electrodes. Gate electrodes are formed over the cathode electrodes while interposing an insulating layer. The gate electrodes have a plurality of opening portions exposing the electron emission regions on the first substrate. A grid electrode is disposed between the first and the second substrates while being spaced apart from the first and the second substrates with a predetermined distance. The grid electrode has opening portions corresponding to the opening portions of the gate electrodes with a size smaller than that of the latter.

In a method of fabricating the electron emission device, cathode electrodes, a first insulating layer and gate electrodes are sequentially formed on a substrate. Opening portions are formed at the gate electrodes and the first insulating layer. A second insulating layer is formed by depositing two or more different kinds of insulating layers on the first insulating layer and the gate electrodes. The deposition is sequentially made from the insulating layer having a high etching rate with respect to an etching solution to the insulating layer having a low etching rate. A focusing electrode is formed on the second insulating layer, and opening portions are formed at the focusing electrode with a size smaller than the size of the opening portions of the gate electrodes. Opening portions are formed at the second insulating layer by etching the portions of the second insulating layer exposed through the opening portions of the focusing electrode. The opening portions of the second insulating layer are gradually enlarged in width as they proceed toward the substrate.

### BRIEF DESCRIPTION OF THE DRAWINGS

FIG. 1 is a partial exploded perspective view of an electron emission device according to a first embodiment of the present invention.

FIG. 2 is a partial sectional view of the electron emission device according to the first embodiment of the present invention.

FIG. 3 is a partial amplified view of the second insulating layer shown in FIG. 2.

FIGS. 4 and 5 are partial amplified sectional views of an electron emission device according to a second embodiment of the present invention.

FIG. 6 is a partial sectional view of an electron emission device according to a third embodiment of the present invention.

FIGS. 7A, 7B, 7C, 7D, 7E, 7F and 7G schematically illustrate the steps of manufacturing the electron emission device according to the first embodiment of the present invention.

### DETAILED DESCRIPTION

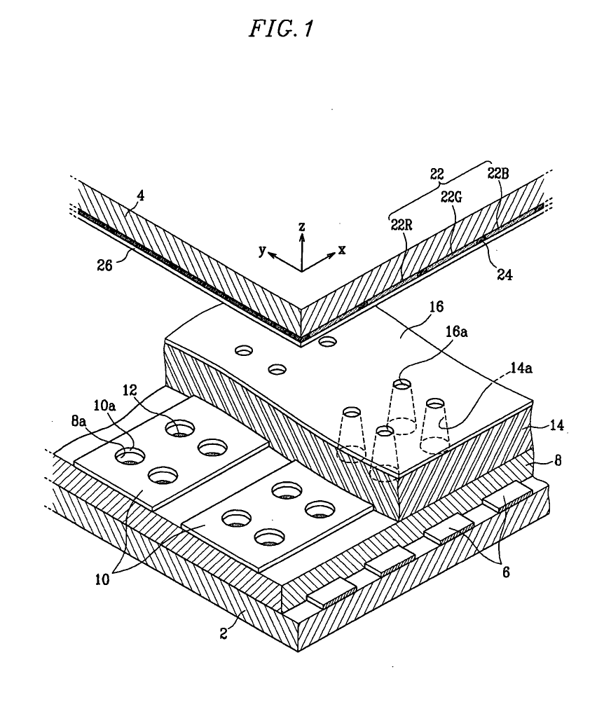

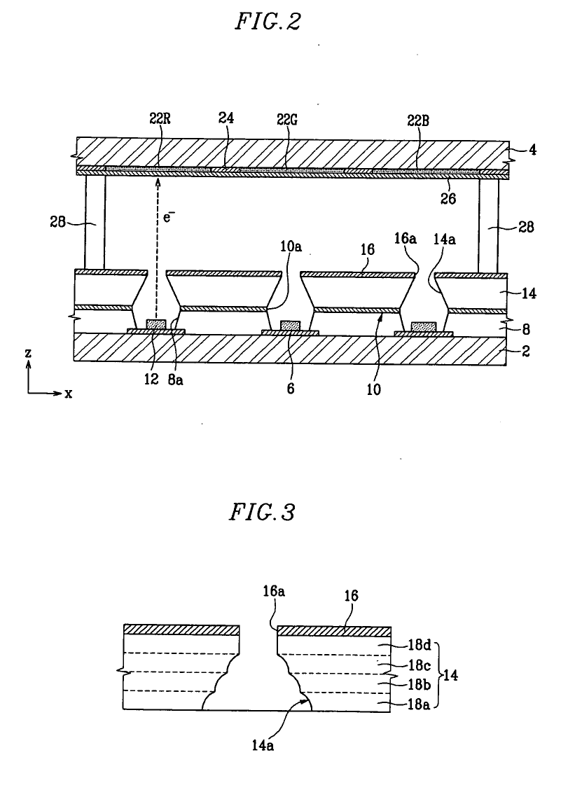

Referring now to FIGS. 1 and 2, the electron emission device includes first and second substrates 2, 4 arranged substantially parallel to each other with an inner space therebetween. An electron emission structure is provided at the first substrate 2 to emit electrons, and a light emission or display structure is provided at the second substrate 4 to emit visible light rays due to the electrons.

Specifically, cathode electrodes 6 are stripe-patterned on the first substrate 2 in a direction of the first substrate 2 (in the y axis direction). A first insulating layer 8 is formed on the entire surface of the first substrate 2 while covering the cathode electrodes 6. Gate electrodes 10 are stripe-patterned on the first insulating layer 8 while proceeding substantially perpendicular to the cathode electrodes 6 (in the x axis direction).

When the crossed regions of the cathode and the gate electrodes 6, 10 are defined as the pixel regions, at least one electron emission region 12 is formed on the cathode electrode 10 per the respective pixel regions. Opening portions 8a, 1Oa are formed at the first insulating layer 8 and the gate electrodes 10 corresponding to the electron emission regions 12 while exposing the electron emission regions 12 on the first substrate 2.

The electron emission regions 12 are formed with a material capable of emitting electrons when applied with an electric field under a vacuum atmosphere, such as a carbonaceous material and a nanometer-sized material. The electron emission regions 12 may be formed with carbon nanotube, graphite, graphite nanofiber, diamond, diamond-like carbon, C₆₀, silicon nanowire, or a combination thereof.

A second insulating layer 14 and a focusing electrode 16 are formed on the gate electrodes 10 and the first insulating layer 8. Opening portions 14a, 16a are formed at the second insulating layer 14 and the focusing electrode 16 while exposing the electron emission regions 12 on the first substrate 2. The opening portions 16a of the focusing electrode 16 are in one to one correspondence with the electron emission regions 12 to surround the trajectory of the electron beams emitted from the respective electron emission regions 12 and increase the efficiency of focusing the electron beams.

It is illustrated in the drawings that the focusing electrode 16 is formed over the entire surface of the first substrate 2, but the focusing electrode 16 may be patterned with a plurality of portions. Furthermore, the focusing electrode 16 may be formed with a metallic layer through deposition, or with a thin metal plate having opening portions 16a formed through mechanical processing or etching.

In this embodiment, the focusing electrode 16 has opening portions 16a smaller than the opening portions 10a of the gate electrodes 10 to reduce the diameter of the electron beams passing through it. The second insulating layer 14 has a thickness larger than that of the first insulating layer 8 such that the focusing electrode 16 is placed at the plane higher than the electron emission regions 12.

The opening portion 16a of the focusing electrode 16 has a width as large as or larger than that of the electron emission region 12. FIGS. 1 and 2 illustrate the case where the opening portion 16a of the focusing electrode 16 has approximately the same width as the electron emission region 12.

The opening portion 14a of the second insulating layer 14 is gradually reduced in width from the bottom surface thereof facing the gate electrodes 10 toward the top surface thereof overlaid with the focusing electrode 16. With the sectional view of the electron emission device, the opening portion 14a of the second insulating layer 14 is formed with an inclined sidewall having a predetermined inclination. The second insulating layer 14 stably supports the whole structure of the focusing electrode 16 to thereby increase the stability of the electron emission structure.

The second insulating layer 14 may have a multi-layered structure with different kinds of insulating layers involving different etching rates with respect to an etching solution. That is, the second insulating layer 14 may be of two or more layers. As shown in the embodiment of FIG. 3, the second insulating layer 14 has four kinds of insulating layers 18a, 18b, 18c, 18d, which exhibit a higher etching rate as they separate from the focusing electrode 16. Accordingly, when the second insulating layer 14 is wet-etched, the opening portion of the insulating layer placed apart from the focusing electrode 16 has a width larger than that of the opening portion of the insulating layer placed close thereto.

In this embodiment, the opening portion of the second insulating layer 14 is shaped as an inverted funnel such that the width thereof is narrowed as it goes apart from the first substrate 2. The focusing electrode 16 is formed on the second insulating layer 14 with opening portions 16a being smaller in width than the corresponding opening portions 10a of the gate electrodes 10. In such a structure, the electrons travel straightly while passing through the opening portions 16a of the focusing electrode 16, and the focusing electrode 16 is placed closer to the trajectory of electron beams, thereby enhancing the efficiency of focusing the electron beams.

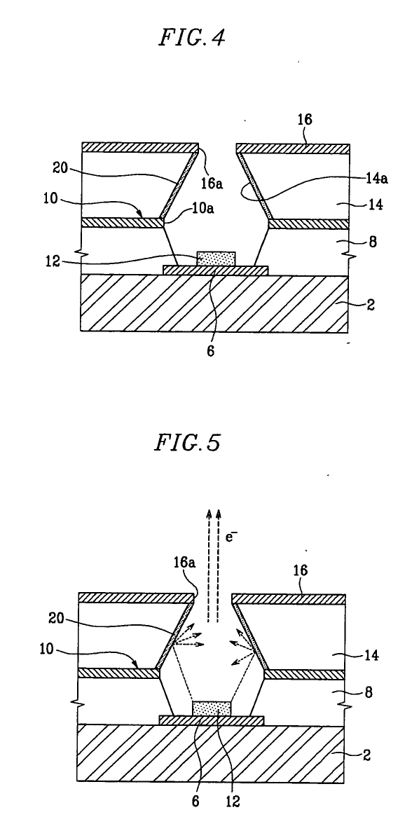

Referring now to FIG. 4, a secondary electron emission layer 20 may be formed on the sidewall of the opening portion 14a of the second insulating layer 14. The secondary electron emission layer 20 emits secondary electrons when the electrons emitted from the electron emission regions 12 pass the first insulating layer 8 and the gate electrodes 10 and collide against the sidewall of the opening portion 14a of the second insulating layer 14, thereby increasing the amount of electrons. The secondary electron emission layer 20 may be formed with an oxide, such as magnesium oxide (MgO).

Referring now back to FIGS. 1 and 2, phosphor layers 22, for example, red, green and blue phosphor layers 22R, 22G, 22B are formed on the surface of the second substrate 4 facing the first substrate 2 while being spaced apart from each other at a predetermined distance, and black layers 24 are formed between the neighboring phosphor layers 22 to enhance the screen contrast.

An anode electrode 26 is formed on the phosphor layers 22 and the black layers 24 with a metallic material, such as aluminum. The anode electrode 26 receives a high voltage required for accelerating the electron beams, and reflects the visible rays radiated toward the first substrate 2 from the phosphor layers 22 to the side of the second substrate 4, thereby increasing the screen luminance.

The anode electrode may be formed with a transparent conductive material, such as indium tin oxide (ITO). In this case, the anode electrode is placed on the surface of the phosphor and the black layers directed toward the second substrate. The anode electrode may be patterned with a plurality of portions.

Spacers 28 are arranged between the first and the second substrates 2, 4, and the first and the second substrates 2, 4 are attached to each other at their peripheries using a low melting point glass, such as a glass frit. The inner space between the first and the second substrates 2, 4 is evacuated to be in a vacuum state, thereby constructing an electron emission device. The spacers 28 are arranged at the non-light emission area where the black layers 24 are placed.

The above-structured electron emission device is driven by applying predetermined voltages to the cathode electrodes 6, the gate electrodes 10, the focusing electrode 16 and the anode electrode 26. For instance, driving voltages with a voltage difference of several to several tens volts are applied to the cathode and the gate electrodes 6, 10, and a minus (−) voltage of several tens volts to the focusing electrode 16, whereas a plus (+) voltage of several hundreds to several thousands volts is applied to the anode electrode 26.

Accordingly, an electric field is formed around the electron emission regions 12 at the pixels where the voltage difference between the cathode and the gate electrodes 6, 10 exceeds a threshold value, and electrons are emitted from the electron emission regions 12. The emitted electrons are focused by the voltage applied to the focusing electrode 16 such that the diffusion angle thereof is reduced, and attracted by the high voltage applied to the anode electrode 26. The electrons are directed toward the second substrate 4, and collide against the corresponding phosphor layers 22, thereby causing light to be emitted from them.

In the above process, the electrons travel with excellent straightness while passing through the opening portions 16a of the focusing electrode 16 due to the reduced size thereof. The focusing electrode 16 is placed close to the trajectory of electron beams, thereby increasing the efficiency of focusing the electron beams.

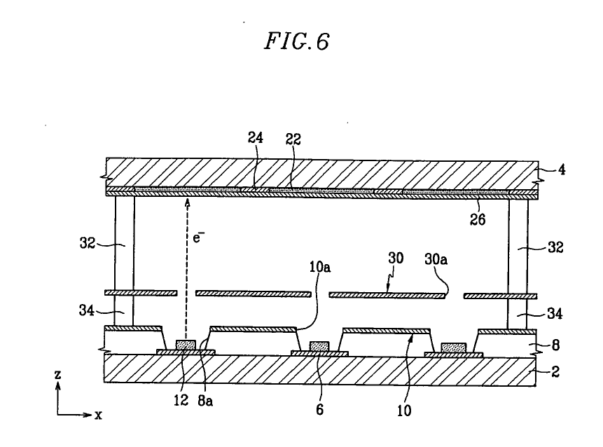

Turning now to FIG. 5, most of the electrons emitted from the electron emission regions 12 while being diffused with a predetermined inclination and the electrons intercepted at the opening portions 16a of the focusing electrode 16 collide against the secondary electron emission layer 20, and the secondary electron emission layer 20 generates a large amount of secondary electrons. Consequently, the electrons within the opening portions 14a of the second insulating layer 14 are amplified while increasing the amount of emitted electrons, and the increased electrons travel with increased straightness while passing through the opening portions 16a of the focusing electrode 16.

Referring now to FIG. 6, an electron emission device according to another embodiment of the present invention has a metallic mesh-shaped grid electrode instead of the focusing electrode of the previous embodiment while omitting the second insulating layer.

The grid electrode 30 is disposed between the first and the second substrates 2, 4 while being spaced apart from them at a predetermined distance by upper and lower spacers 32, 34. Opening portions 30a are formed at the grid electrode 30 corresponding to the opening portions 10a of the gate electrodes 10 with a size smaller than the latter. The electron beam focusing effect due to the reduced size of the opening portions 30a of the grid electrode 30 is comparable to that of the previous embodiment, and hence, detailed explanation thereof will be omitted.

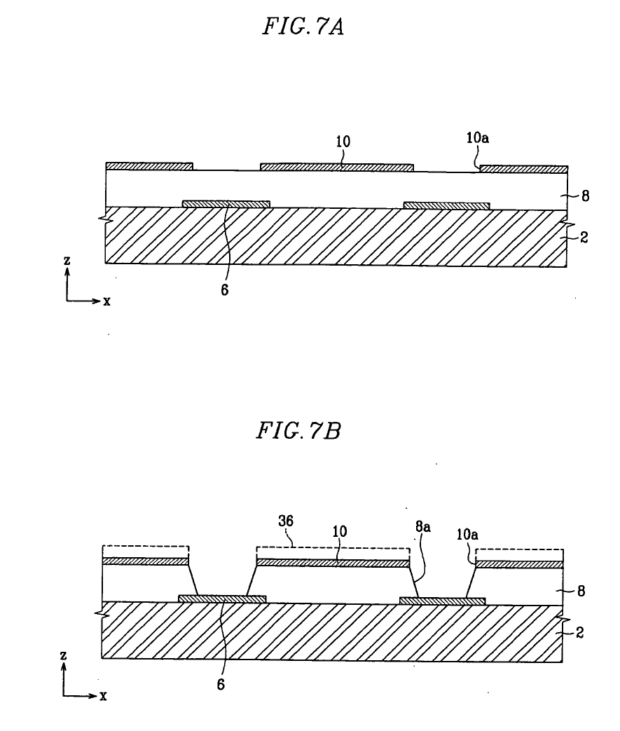

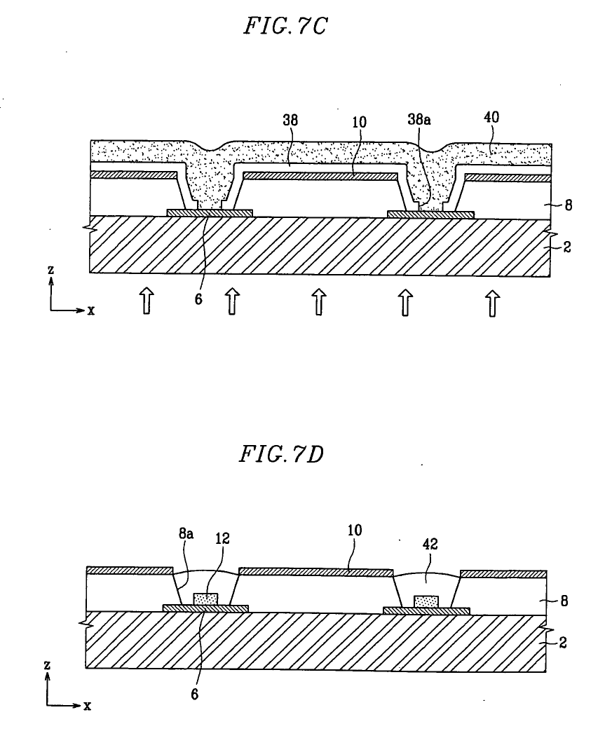

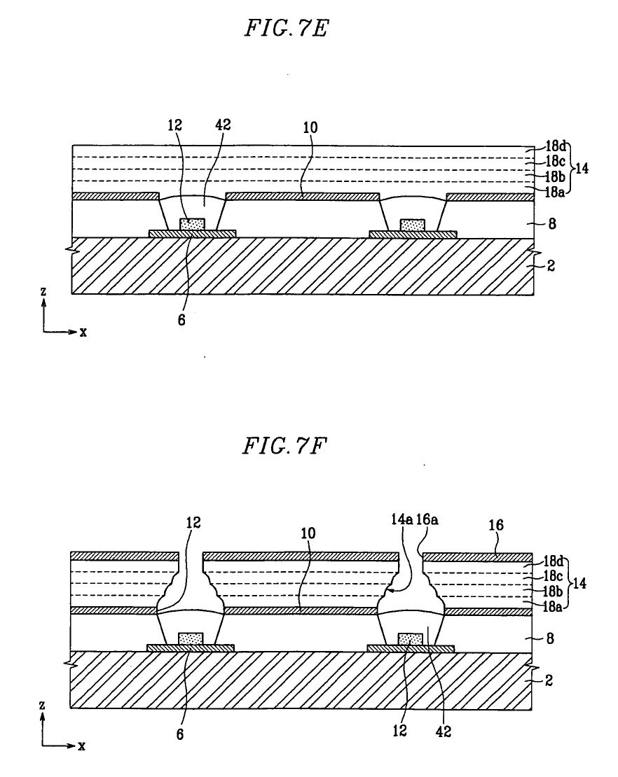

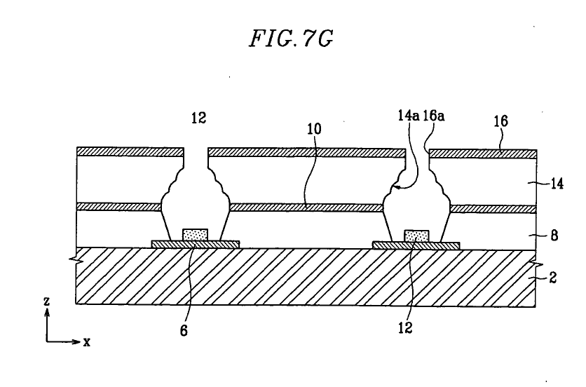

A method of manufacturing the electron emission device according to the first embodiment of the present invention will be now explained with reference to FIGS. 7A to 7G.

As shown in FIG. 7A, a conductive film is coated onto the first substrate 2, and patterned to thereby form cathode electrodes 6 in a direction of the first substrate 2. An insulating material is printed onto the entire surface of the first substrate 2 to form a first insulating layer 8. The cathode electrodes 6 may be formed with a transparent conductive material, such as ITO. The first insulating layer 8 may be formed with a thickness of 5-20 μm through repeating the screen printing several times.

A conductive film is coated onto the first insulating layer 8, and patterned, thereby forming gate electrodes 10 proceeding perpendicular to the cathode electrodes 6, and forming opening portions 10a at the crossed regions thereof with the cathode electrodes 6.

As shown in FIG. 7B, a photoresist pattern 36 is formed on the first insulating layer 8 and the gate electrodes 10, and the first insulating layer 8 is etched using the photoresist pattern 36 as a mask layer, thereby forming opening portions 8a at the first insulating layer 8. Thereafter, the photoresist pattern 36 is detached, and removed.

As shown in FIG. 7C, a sacrificial layer 38 is formed on the entire area over the structure formed on the first substrate 2, and patterned to form opening portions 38a at the area to be formed with electron emission regions. A paste-phased mixture 40 containing an electron emission material and a photosensitive material is then applied onto the sacrificial layer 38. Ultraviolet rays are illuminated onto the paste-phased mixture 40 filled within the opening portions 38a of the sacrificial layer 38 from the backside of the first substrate 2 to harden it. After the non-hardened mixture is removed, the sacrificial layer 38 is removed to thereby complete the electron emission device shown in FIG. 7D.

When the sacrificial layer 38 is used to form the electron emission regions 12, the extension of the electron emission regions 12 over the cathode and the gate electrodes 6, 10 is inhibited to thereby prevent a possible short circuit between the two electrodes. The method of forming the electron emission regions 12 is not limited to the above.

As shown in FIG. 7D, a photoresist material is applied to the opening portions 8a of the first insulating layer 8 such that a protective layer 42 covers the electron emission regions 12.

As shown in FIG. 7E, a second insulating layer 14 is formed on the first insulating layer 8 and the gate electrodes 10. The second insulating layer 14 has a multi-layered structure with different kinds of insulating layers 18a, 18b, 18c, 18d, which involve different etching rates with respect to an etching solution, and are sequentially formed from the one having a relatively high etching rate to the other having a relatively low etching rate. With the formation of the second insulating layer 14, the whole thickness of the second insulating layer 14 is established to be larger than the thickness of the first insulating layer 8, thereby increasing the electron beam focusing effect of a focusing electrode to be formed later.

As shown in FIG. 7F, a focusing electrode 16 is formed on the second insulating layer 14, and patterned to form opening portions 16a corresponding to the electron emission regions 12. The opening portions 16a of the focusing electrode 16 are established to be smaller than the opening portions 10a of the gate electrodes 10.

The portions of the second insulating layer 14 exposed through the opening portions 16a of the focusing electrode 16 are etched using an etching solution. Consequently, the opening portion formed at the insulating layer placed apart from the focusing electrode 16 has a width larger than that of the opening portion formed at the insulating layer placed close to the focusing electrode 16 such that the opening portions 14a of the second insulating layer 14 are shaped as an inverted funnel. The protective layer 42 covering the electron emission regions 12 is removed to thereby complete the electron emission structure shown in FIG. 7G.

The first substrate 2 with the above-described electron emission structure and the second substrate 4 with phosphor layers 22, black layers 24 and an anode electrode 26 are assembled in a body, and the inner space between the substrates 2, 4 is exhausted to thereby construct an electron emission device.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An electron emission device comprising:
a substrate;
cathode electrodes formed on the substrate;
electron emission regions electrically connected to the cathode electrodes;
gate electrodes formed over the cathode electrodes while interposing a first insulating layer, the gate electrodes having a plurality of opening portions exposing the electron emission regions on the substrate; and
a focusing electrode formed over the first insulating layer and the gate electrodes with a second insulating layer interposed between the focusing electrode and the gate electrode, the focusing electrode having opening portions corresponding to the opening portions of the gate electrodes with a size smaller than the size of the opening portions of the gate electrodes.

2. The electron emission device of claim 1, wherein the opening portion of the focusing electrode has a width larger than or as large as the width of the electron emission region.

3. The electron emission device of claim 1, wherein the second insulating layer has a thickness larger than a thickness of the first insulating layer.

4. The electron emission device of claim 1, wherein the second insulating layer has opening portions communicating with the opening portions of the focusing electrode, and the opening portions of the second insulating layer are gradually enlarged in width from the focusing electrode toward the substrate.

5. The electron emission device of claim 4, wherein the second insulating layer has a multi-layered structure with insulating layers having different etching rates.

6. The electron emission device of claim 5, wherein the etching rate of the insulating layer placed apart from the focusing electrode is higher than the etching rate of the insulating layer placed close to the focusing electrode.

7. The electron emission device of claim 4, further comprising a secondary electron emission layer provided at the sidewall of the opening portion of the second insulating layer.

8. The electron emission device of claim 1, wherein the electron emission regions are formed with a material selected from the group consisting of carbon nanotube, graphite, graphite nanofiber, diamond, diamond-like carbon, C₆₀, silicon nanowire, and a combination thereof.

9. The electron emission device of claim 1, further comprising at least one anode electrode formed on another substrate facing the substrate, and phosphor layers formed on a surface of the anode electrode.

10. An electron emission device comprising:
first and second substrates facing each other;
cathode electrodes formed on the first substrate;
electron emission regions electrically connected to the cathode electrodes;
gate electrodes formed over the cathode electrodes while interposing an insulating layer, the gate electrodes having a plurality of opening portions exposing the electron emission regions on the first substrate; and
a grid electrode disposed between the first and the second substrates while being spaced apart from the first and the second substrates with a predetermined distance, the grid electrode having opening portions corresponding to the opening portions of the gate electrodes with a size smaller than the size of the opening portions of the gate electrodes.

11. The electron emission device of claim 10, further comprising at least one anode electrode formed on the second substrate, and phosphor layers formed on a surface of the anode electrode.

12. A method of manufacturing an electron emission device comprising:
sequentially forming cathode electrodes, a first insulating layer and gate electrodes on a substrate;
forming opening portions at the gate electrodes and the first insulating layer;
forming a second insulating layer by depositing two or more different insulating layers over the first insulating layer and the gate electrodes, the deposition being sequentially made from an insulating layer having a high etching rate to an insulating layer having a low etching rate;
forming a focusing electrode on the second insulating layer, and forming opening portions at the focusing electrode with a size smaller than the size of the opening portions of the gate electrodes; and
forming opening portions at the second insulating layer by etching the portions of the second insulating layer exposed through the opening portions of the focusing electrode, the opening portions of the second insulating layer being gradually enlarged in width from the focusing electrode to the substrate.

13. The method of claim 12, further comprising forming electron emission regions on the cathode electrodes within the opening portions of the first insulating layer between forming opening portions at the gate electrodes and forming a second insulating layer.

14. The method of claim 13, wherein a protective layer is formed at the opening portion of the first insulating layer while covering the electron emission region, and after the formation of the opening portion at the second insulating layer, the protective layer is removed.

15. The method of claim 12, wherein with the formation of the second insulating layer, the whole thickness of the second insulating layer is established to be larger than the thickness of the first insulating layer.

16. An electron emission device comprising:
a cathode electrode formed on a substrate;
an electron emission region electrically connected to the cathode electrode;
a first insulating layer formed over the cathode electrode and having a first insulating layer opening exposing the electron emission region;
a gate electrode formed over the first insulating layer and having a gate electrode opening exposing the electron emission region;
a second insulating layer formed over the gate electrode and having a second insulating layer opening exposing the electron emission region; and
a focusing electrode formed over the second insulating and having a focusing electrode opening exposing the electron emission region;
wherein:
the first insulating layer opening widens from the cathode electrode toward the gate electrode;
the second insulating layer opening narrows from the gate toward the focusing electrode; and
the focusing electrode opening is smaller than the gate electrode opening.

17. The electron emission device of claim 16, wherein the focusing electrode opening is larger than, or as large as, a width of the electron emission region.

18. The electron emission device of claim 16, wherein the second insulating layer has a second insulating layer thickness larger than a first insulating layer thickness.

19. The electron emission device of claim 16, wherein the second insulating layer has a multi-layered structure with insulating layers of different etching rates.

20. The electron emission device of claim 16, wherein a secondary electron emission layer is provided on the second insulating layer opening.
